(19) United States
(12) Patent Application Publication
(10) Pub. No.: US 2023/0063529 A1
(43) Pub. Date: Mar. 2, 2023

(54) BICYCLE REAR SUSPENSION SYSTEM

(71) Applicant: Suspension Formulas, LLC, Layton, UT (US)

(72) Inventor: Christopher Canfield, Layton, UT (US)

(21) Appl. No.: 17/464,484

(22) Filed: Sep. 1, 2021

(51) Int. Cl. B62K 25/26; B62K 25/28; B62K 19/38

(52) U.S. Cl. CPC B62K 25/26; B62K 25/286; B62K 19/38

(57) ABSTRACT

A bicycle is disclosed. In certain examples, the bicycle includes a head tube coupled to a top tube and a down tube, and a seat tube coupled to the top tube and the down tube. The bicycle is coupled to a rear suspension system in certain examples. The rear suspension includes an upper linkage member pivotally coupled at a first pivot point with the bicycle frame and pivotally coupled at a second pivot point with a rear suspension system. The rear suspension also includes a lower linkage member pivotally coupled at a first pivot point with the bicycle frame and pivotally coupled at a second pivot point with the rear suspension system, and where the lower linkage member includes a bottom bracket shell.

### FIELD

This disclosure is in the field of suspension systems, and more specifically, relates to rear suspension systems for wheeled vehicles such as mountain bikes and motorcycles.

### BACKGROUND

Due to the increase in consumer interest and demand and the advent of extreme sports competitions, the technology for recreational vehicles such as mountain bikes and motorcycles has advanced considerably in recent decades. One area of ongoing interest and development is the suspension systems of such vehicles, especially as relating to their performance, handling and safety. As known to one of skill in the art, for example, when there is an increase in power to the driving wheel or wheels of a bicycle, a motorcycle and other wheeled vehicle (e.g., normally the rear wheel in a bicycle or motorcycle), so as to slow the vehicle, some of the force being transmitted to wheel can be cross-coupled into the frame and bind the suspension system to the frame, preventing articulation. This can be problematic for several reasons.

### SUMMARY

The subject matter of the present application has been developed in response to the present state of the art, and in particular, in response to the problems and needs in the art that have not yet been fully solved by currently available wheeled vehicle suspension systems. Accordingly, the subject matter of the present application has been developed to provide a suspension system for wheeled vehicles, as well as methods of making a suspension system for wheeled vehicles, that overcome at least some shortcomings of the currently available suspension systems found in the prior art.

For example, according to one representative example a bicycle includes a head tube coupled to a top tube and a down tube, and a seat tube coupled to the top tube and the down tube. The bicycle is coupled to a rear suspension system in certain examples. The rear suspension includes an upper linkage member pivotally coupled at a first pivot point with the bicycle frame and pivotally coupled at a second pivot point with a rear suspension system. The rear suspension also includes a lower linkage member pivotally coupled at a first pivot point with the bicycle frame and pivotally coupled at a second pivot point with the rear suspension system, and where the lower linkage member includes a bottom bracket shell.

In certain examples, the bottom bracket shell is integrally formed with the lower linkage member. The lower linkage member, in certain examples includes a third pivot point that is coupled to a shock absorber. Alternatively, the upper linkage member includes a third pivot point that is coupled to the shock absorber.

In certain examples, the rear suspension system comprises a seatstay, and a chainstay oriented to form, together with a structural member, a rear triangle. The rear suspension system is configured to support a wheel and move the wheel, with respect to the bicycle frame, from an extended position to a compressed position. The upper linkage member, in certain examples, pivotally couples to an end of the seatstay and the lower linkage member pivotally couples to an end of the chainstay. In certain examples, the bicycle includes a rear braking system coupled to either the seatstay, or the chainstay.

A method is also disclosed, and includes providing the frame of a vehicle having a head tube, a down tube, and a seat tube, and providing an upper linkage member pivotally coupled at a first pivot point with the frame and pivotally coupled at a second pivot point with a rear suspension system. The method also includes providing a lower linkage member pivotally coupled at a first pivot point with the frame and pivotally coupled at a second pivot point with the rear suspension system, and where the lower linkage member includes a bottom bracket shell.

### BRIEF DESCRIPTION OF THE DRAWINGS

In order that the advantages of the subject matter of the present disclosure will be readily understood, a more particular description of the subject matter will be rendered by reference to specific examples that are illustrated in the appended drawings. Understanding that these drawings depict only typical examples of the subject matter of the present disclosure and are not therefore to be considered to be limiting of its scope, the subject matter will be described and explained with additional specificity and detail through the use of the accompanying drawings, in which:

FIG. 1 is a side view diagram illustrating one example of a bicycle frame of a mountain bike-type bicycle having a rear suspension system, in accordance with examples of the subject disclosure;

FIG. 2 is a side view diagram illustrating one example of the rear suspension system articulating or compressing upon encountering an obstacle, according to examples of the subject disclosure;

FIG. 3 is a side view diagram illustrating another example of a bicycle frame of a mountain bike-type bicycle having a rear suspension system, in accordance with examples of the subject disclosure;

FIG. 4 is a side view diagram illustrating another example of a bicycle frame having a rear suspension system, in accordance with examples of the subject disclosure;

FIG. 5 is a side view diagram illustrating another example of a bicycle frame having a rear suspension system, in accordance with examples of the subject disclosure;

FIG. 6 is a side view diagram illustrating another example of a bicycle frame having a rear suspension system, in accordance with examples of the subject disclosure;

FIG. 7 is a flow chart depicting a method of making a suspension system for supporting a frame of a vehicle on at least one wheel of the vehicle, in accordance examples of the subject disclosure; and

FIG. 8 is a side view diagram illustrating another example of a bicycle frame having a rear suspension system, in accordance with examples of the subject disclosure.

The drawings are not necessarily drawn to scale.

### DETAILED DESCRIPTION

The subject matter of the present disclosure has been developed in response to the present state of the art in wheeled vehicle suspension systems. In particular, the subject matter of the present disclosure addresses the lack of a rear suspension system for mountain bike-type bicycles that are configured to effectively de-couple the suspension system from the driving forces transmitted along a tension segment of a drive chain throughout the range of motion of the suspension system. However, it is contemplated that the present disclosure is not limited to mountain bike-type bicycles, and also has application with upright and recumbent road bicycles and other chain-driven vehicles such as motorcycles, three- and four-wheeled recreational vehicles, etc., which suffer from the same shortcomings. Accordingly, the subject matter of the present disclosure has been developed to provide a suspension system for wheeled vehicles and a method of making a suspension system for wheeled vehicles that may overcome many or all of the above-discussed or other shortcomings in the art.

Reference throughout this specification to features, advantages, or similar language does not imply that all of the features and advantages that may be realized with the subject matter of the present disclosure should be or are in any single example of the subject matter. Rather, language referring to the features and advantages is understood to mean that a specific feature, advantage, or characteristic described in connection with an example is included in at least one example of the subject matter of the present disclosure. Thus, discussion of the features and advantages, and similar language, throughout this specification may, but do not necessarily, refer to the same example.

Furthermore, the described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation.

In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

Similarly, reference throughout this specification to “one example”, “an example”, “a representative example”, or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the subject matter of the present disclosure, however, absent an express correlation to indicate otherwise, an implementation may be associated with one or more examples.

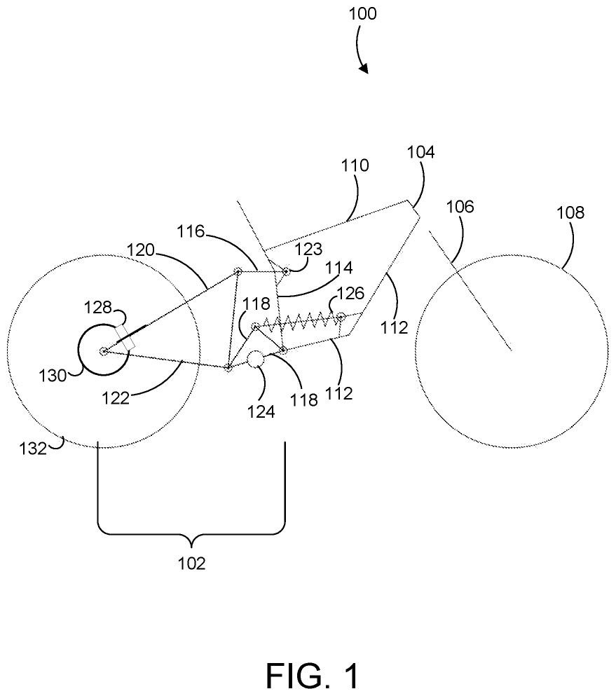

Illustrated in FIGS. 1-6 are several representative examples of a suspension system for wheeled vehicles, which examples also include one or more methods of making the suspension system. As described herein, the suspension system provides several significant advantages and benefits over other suspension systems and methods of making the suspension systems. However, the recited advantages are not meant to be limiting in any way, as one skilled in the art will appreciate that other advantages may also be realized upon practicing the present disclosure

FIG. 1 is a side view diagram illustrating one example of a bicycle frame 100 of a mountain bike-type bicycle having a rear suspension system 102. The frame 100 includes a head tube 104 which supports a front fork 106 and a front suspension system which provides the connection between a front wheel 108 and the frame 100. In addition to the head tube 104, the basic components of the frame 100 may include the top tube 110, the down tube 112, the seat tube 114.

The rear suspension system 102, as will be recognized by one of skill in the art, may be configured in many different configurations, including but not limited to, the examples depicted in FIGS. 1-6. In each example, the rear suspension system 102 is pivotally coupled to the frame 100 (also referred to as the “front triangle”) via two or more linkage members. As depicted in FIG. 1, the front triangle 100 couples to the rear suspension system 102 (also referred to as the “rear triangle”) via an upper linkage member 116 and a lower linkage member 118.

In certain examples, the upper linkage member 116 couples a seatstay 120 of the rear suspension system 102 to the seat tube 114 of the frame 100. The upper linkage member 116, in certain examples, is pivotally coupled at a first end to the frame 100 and is pivotally coupled at a second end to the seatstay 120. The first end of the upper linkage member couples to a pivot point 123 formed in the frame 100 (e.g., formed in the seat tube 114). Any type of suitable fastener may be used to couple the upper linkage member 116 to the pivot point 123. As used herein, the term “seat tube” refers to any member or grouping of members, structural or otherwise, that is/are disposed between the top tube 110 and the down tube 112. For example, the seat tube 114 may be a single tube or bar, or alternatively, the seat tube 114 may be formed of combinations of tubes, bars, plates, rods, etc.

In certain examples, the lower linkage member 118 couples a chainstay 122 of the rear suspension system 102 with the frame 100. The lower linkage member 118 includes a first end that is pivotally coupled with the frame 100 and a second end that is pivotally coupled with the chainstay 122. In certain examples, the lower linkage member 118 is formed having a bottom bracket shell 124. Examples of different suspension configurations suitable for use with the present disclosure will be described in greater detail below with reference to how the rear suspension system 102 is coupled at different pivot points to create different wheel/axle paths, different amounts of suspension travel, etc. However, in each example the bottom bracket shell 124 is “floating” or movable with respect to the frame 100. Stated differently, the bottom bracket shell 124 is disposed within a linkage member coupled to the frame 100, as depicted, and not rigidly mounted or formed in the front triangle.

Such a configuration has many beneficial features, which will be described in greater detail below, but include and are not limited to, allowing a rear wheel braking system to be mounted on a floating member to prevent binding during a braking event, allow for a rear suspension system 102 with a rearward wheel path. Rearward axle paths are faster and smoother at absorbing bumps. However, because of the growth in the chain of a rearward axle path suspension system, conventional mountain bike designs use an idler pulley to fix the chain growth issue, but idler pulleys cause drag and pedal inefficiencies and are hard to pedal uphill compared to a chain that goes directly to the front chainring. Beneficially, with the bottom bracket shell in the lower linkage member, the bottom bracket is allowed to move rearward with the axle to minimize chain growth and eliminate the need of an idler pulley.

Additionally, this suspension system of the current disclosure, with two or more linkage members, allows the rear brake to be mounted on a structural member (rear triangle or chainstay or seatstay) that is not directly connected to the front frame. By having the brake mounted with two or more links between it and the front frame the rear brake forces are isolated and free the rear wheel to move with the terrain and react to the incoming bumps. Conversely, if the brake is mounted to a structural member that is directly connected to the front frame, braking forces lock up the movement of the rear wheel and the rear wheel then bounces off incoming bumps, which brakes traction, and reduces rider control of the bike. Beneficially, the braking system of the current disclosure is allowed to move with the incoming bumps and maintain contact (i.e., traction) with the ground and give the rider more ability to slow down.

Another benefit of the current disclosure, due to the bottom bracket shell being in the lower linkage member, is increasing the pedaling efficiency of pedaling and power transfer to the rear wheel. By having the rider's weight on the lower linkage member, the driving system is held down under pedaling. Holding the system steady when spinning the chain to the rear wheel. This results in a very efficient power transfer from the rider or motor to the wheel. Other systems without the bottom bracket in the lower linkage member rely on a balancing act of the tension side of the chain with regard to an instant center point. If above the tension side of the chain is directed above the instant center, the system lifts; if below the instant center, the system will bounce or pull up into the shock. Both are using the rider's energy to pedal- to pull up or down on the system instead of driving the force to the rear wheel. Beneficially, by mounting or integrating the bottom bracket shell into the lower linkage member, the pedaling forces are held steady by the rider weight causing the pedaling forces to be directed to the rear wheel, which reduces pedal bob.

In certain examples, the frame 100 includes a shock absorber 126. The shock absorber 126 may be pivotally connected to the frame 100 (or a structural member of the frame) and a structural member of the rear suspension system 102. Additionally, the shock absorber 126 may couple the frame 100 to the rear suspension system 102 via the lower linkage member 118. The shock absorber 126 automatically compresses when forces are applied to the end of the shock absorber 126 and biases the rear suspension system 102 with reference to the frame 100. The forces include, but are not limited to, weight loading (e.g., weight of bike and/or weight of rider), dynamic loading due to irregularities in the terrain, and driving forces applied to pedals of the bike. As depicted and described here, the shock absorber 126 may be oriented in many different configurations including, but not limited to, substantially horizontally, substantially vertically, substantially parallel with a portion of the down tube 112, substantially parallel with the seat tube 114, at an angle with regard to the seat tube 114, etc. In other examples, the shock absorber 126 is coupled at an end with either the upper linkage member 116 or the lower linkage member 118. In other examples, the shock absorber 126 is pivotally coupled with other intermediate linkage members.

The bicycle, in certain examples, also includes a braking system 128 for applying a braking force to the rear wheel. For example, the braking system 128 may include a caliper system for pressing pairs of pads against a disc 130 (i.e., rotor). This action slows the rotation of the rear wheel 132 which is rotationally coupled with the disc 130. The braking system 128 may be rigidly coupled with the seatstay 120. In other examples, the braking system 128 is rigidly coupled with the chainstay 122. As mentioned briefly, the examples of the present disclosure beneficially prevent binding or locking of the suspension system. Locking of the suspension system is a problem for all mountain bike riders, but in particular for downhill mountain bike riders. Essentially, with regard to conventional mountain bikes with a bottom bracket shell in the front triangle, when a rider activates the braking system, a chain (that rotationally couples the rear wheel with a crank in the bottom bracket shell) binds or locks the rear suspension and prevents the rear suspension from floating with regard to the front triangle. This greatly affects the ability of the rider to control the mountain bike during the descent because the wheel is frequently breaking traction with the terrain. The rear suspension of conventional bikes, under heavy breaking, is not able to articulate and maintain contact with the ground. Additionally, the shock absorber is not allowed to absorb impacts while the rear suspension is bound, and the force of the impacts are therefore transferred to the rider. However, the present disclosure overcomes these limitations by positioning the bottom bracket shell 124 in an articulating linkage member (i.e., linkage member 118). Accordingly, under a braking event, a chain (not shown) may only bind the rear triangle with the lower linkage member 118 while still allowing the rear suspension system 102 to move with respect to the frame 100. Additionally, the shock absorber 126 is allowed absorb impacts.

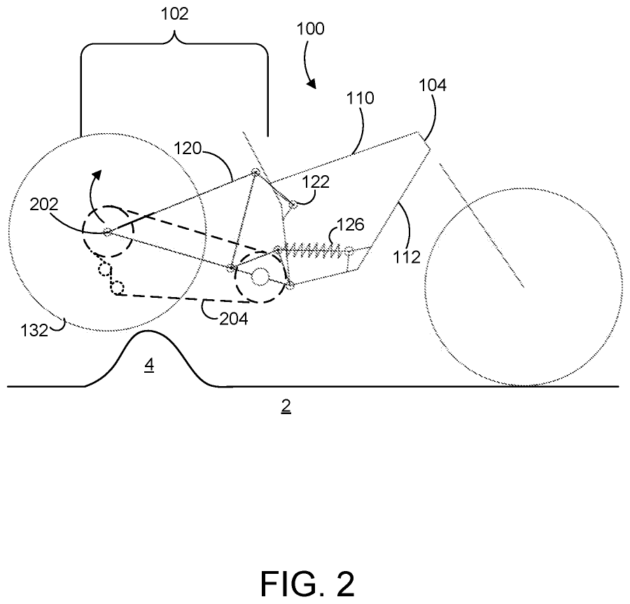

FIG. 2 is a side view diagram illustrating one example of the rear suspension system 102 articulating or compressing upon encountering an obstacle, according to examples of the subject disclosure. Together, FIGS. 1 and 2 illustrate an extended position (see FIG. 1) and a compressed position (see FIG. 2) according to examples of the subject disclosure. The rear suspension system 102 is configured to receive and rotatably support an axle 202 of the rear wheel or tire 132. The bicycle includes a chain ring 17, located on the lower linkage member 118, coupled to the wheel 132 via a chain 204 that is rotatable to apply a driving force to the wheel 132 along a tension segment of the chain 204. The rear suspension system 102 is configured to move up and down relative to the frame 100 of the bicycle. This movement allows the rear wheel 132 to rotate upwards from the normally extended position as depicted to a compressed position in order to accommodate an obstacle or bump 4 on the ground surface 2 over which the bicycle is traveling.

Unlike conventional rear suspension systems, the rear suspension system 102 of FIGS. 1-6 reacts the same to the obstacle 4 regardless of the braking force applied to the rear wheel 132. Beneficially, the described examples allow for a rearward wheel path 206 and a braking system that does not bind the rear suspension system 102 to the frame 100 under braking. As used herein, a “rearward wheel path” refers to a path followed by the axle 202 that initially moves away from the frame 100 when the rear suspension system 102 moves from the extended position to the compressed position. This allows for the rear wheel 132 to better navigate obstacles than rear suspension systems that forward wheel paths.

The shock absorber 126 has an adjustable length and is configured to automatically compress in response to forces applied between the two ends of the shock absorber 126. These forces include the weight loading provided by the weight of the frame 100 of the bicycle as well as weight of the rider. These forces also include the dynamic loading caused by bumps 4 and irregularities in the ground surface 2 being transmitted upwards from the rear wheel towards the frame 100 as the bike travels over the ground surface 2. The dynamic loading can be reduced or eliminated through the use of a damper element which can be integrated with the shock absorber 126 (e.g., a spring, or air shock).

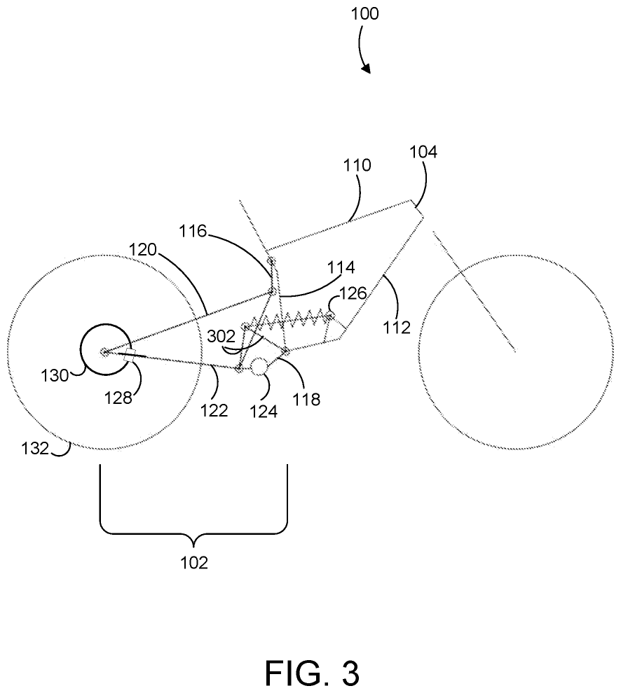

FIG. 3 is a side view diagram illustrating another example of a bicycle frame 100 of a mountain bike-type bicycle having a rear suspension system 102, in accordance with examples of the subject disclosure. In the depicted example, the rear suspension system 102 is coupled to the frame 100 (or “front triangle”) in a manner similar to that of FIGS. 1 and 2. However, the upper linkage member 116, when the rear suspension system 102 is in an extended position, is oriented in a nearly vertical orientation. The upper linkage member 116 may be coupled directly to a pivot point within the seat tube 114, as compared to the mount point 122 described above with reference to FIG. 1.

Various other configurations of the depicted example are contemplated. For example, the seatstay 120 of FIG. 3 is significantly longer than the chainstay 122. The lower linkage member 118, in certain examples, includes the bottom bracket shell 124 and upper structural member 302 in a semi-triangular relationship. The upper structural members 302, in certain examples, couple the lower linkage member 118 with the shock absorber 126. The lower linkage member 118, in certain examples, includes three pivot points which allow the lower linkage member 118 to couple with the frame 100, the shock absorber 126, and the chainstay 122 of the rear suspension system 102. As discussed above, the rear braking system 128 may be mounted on the chainstay 122 (as depicted in FIG. 3) or to the seatstay 120 (as depicted in FIG. 1).

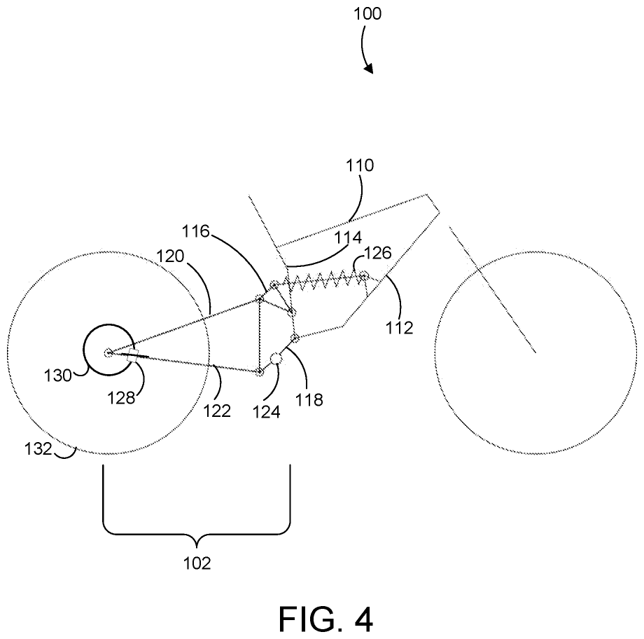

FIG. 4 is a side view diagram illustrating another example of a bicycle frame 100 having a rear suspension system 102, in accordance with examples of the subject disclosure. In certain examples, the frame 100 may be coupled to the rear suspension system 102 with an upper linkage member 116 that includes 3 pivot or mounting points and a lower linkage member 118 that includes 2 pivot or mounting points. The upper linkage member 116, in certain examples, is a triangular-shaped member that includes pivot points for coupling to the seatstay 120, the shock absorber 126, and the seat tube 114 (or another mounting point of the frame 100).

In certain examples, the lower linkage member 118 is formed having the bottom bracket shell 124 and a pair of pivot points for pivotally coupling the frame 100 with the chainstay 122 of the rear suspension system. In this configuration, the bottom bracket shell 124 is floating with reference to the frame 100, even under a braking event.

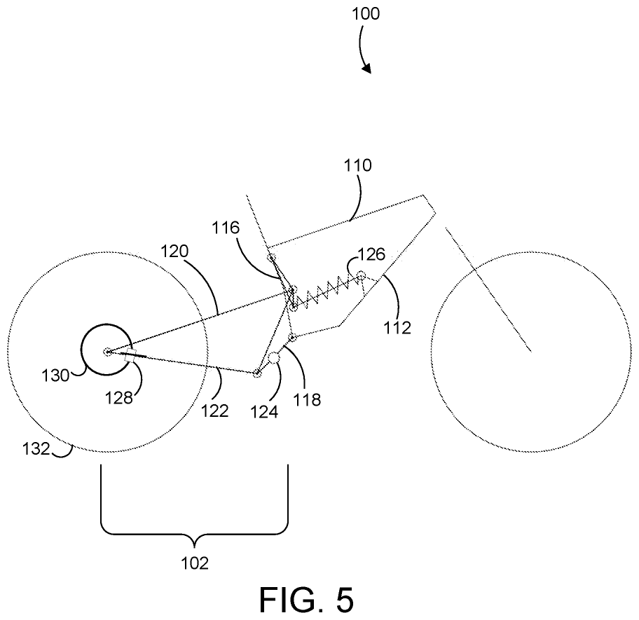

FIG. 5 is a side view diagram illustrating another example of a bicycle frame 100 having a rear suspension system 102, in accordance with examples of the subject disclosure. In certain examples, the frame 100 may be coupled to the rear suspension system 102 with an upper linkage member 116 that includes 3 pivot or mounting points and a lower linkage member 118 that includes 2 pivot or mounting points. The upper linkage member 116, in certain examples, is a compressed triangular-shaped member that includes pivot points for coupling to the seatstay 120, the shock absorber 126, and the seat tube 114 (or another mounting point of the frame 100). In the depicted example, the upper linkage member 116 positions the end of the seatstay 120 within the forward triangle (i.e., frame 100). Different seatstay 120 lengths and chainstay 122 lengths are contemplated that would alter the geometry of the rear suspension system 102 with respect to the frame 100. It is contemplated that the upper linkage member 116 and the lower linkage member 118 may be modified to accommodate whichever lengths of seatstay 120 and chainstay 122 are selected.

In certain examples, the lower linkage member 118 is formed having the bottom bracket shell 124 and a pair of pivot points for pivotally coupling the frame 100 with the chainstay 122 of the rear suspension system. In this configuration, the bottom bracket shell 124 is floating with reference to the frame 100, even under a braking event.

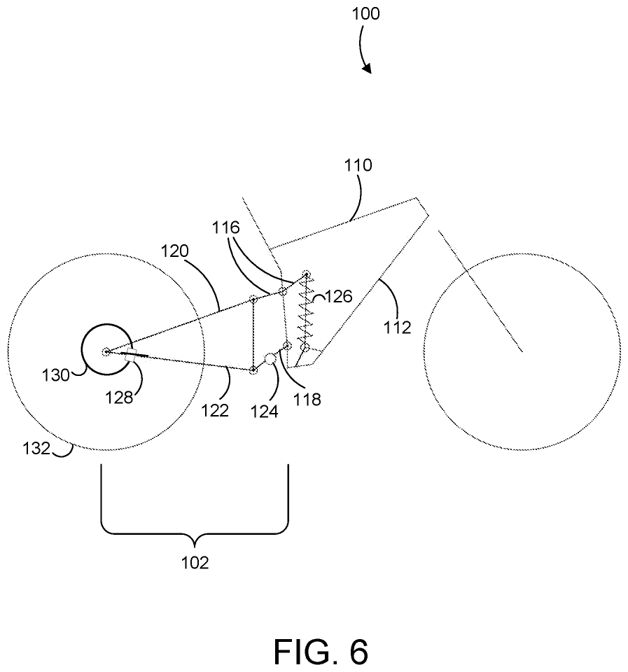

FIG. 6 is a side view diagram illustrating another example of a bicycle frame 100 having a rear suspension system 102, in accordance with examples of the subject disclosure. In certain examples, the frame 100 may be coupled to the rear suspension system 102 with an upper linkage member 116 that includes 3 pivot or mounting points and a lower linkage member 118 that includes 2 pivot or mounting points. The upper linkage member 116, in certain examples, is a rocker arm member that includes pivot points for coupling to the seatstay 120, the shock absorber 126, and the seat tube 114 (or another mounting point of the frame 100). In the depicted example, the shock absorber 126 is oriented in a nearly vertical position. Different seatstay 120 lengths and chainstay 122 lengths are contemplated that would alter the geometry of the rear suspension system 102 with respect to the frame 100. It is contemplated that the upper linkage member 116 and the lower linkage member 118 may be modified to accommodate whichever lengths of seatstay 120 and chainstay 122 are selected.

In certain examples, the lower linkage member 118 is formed having the bottom bracket shell 124 and a pair of pivot points for pivotally coupling the frame 100 with the chainstay 122 of the rear suspension system. In this configuration, the bottom bracket shell 124 is floating with reference to the frame 100, even under a braking event.

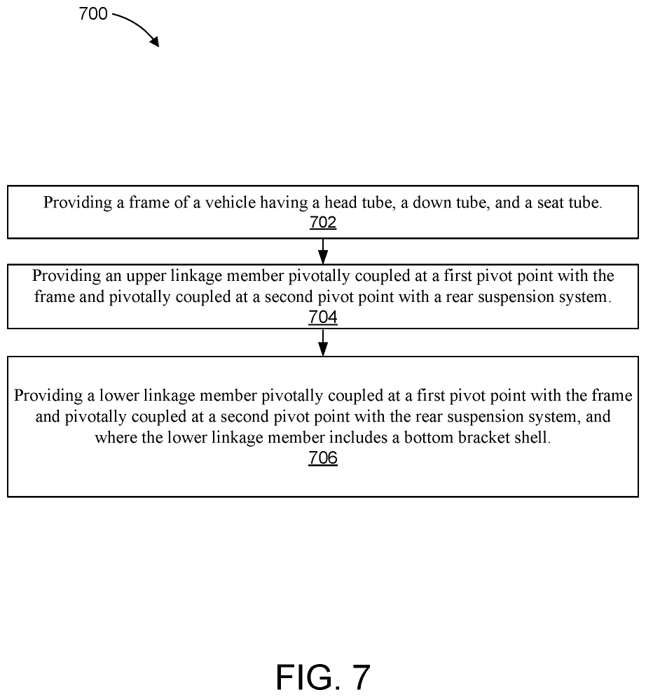

FIG. 7 is a flow chart depicting a method 700 of making a suspension system for supporting a frame of a vehicle on at least one wheel of the vehicle, in accordance examples of the subject disclosure. The method includes providing 702 a frame of a vehicle having a head tube, a down tube, and a seat tube. In certain examples, the method also includes providing 704 an upper linkage member pivotally coupled at a first pivot point with the frame and pivotally coupled at a second pivot point with a rear suspension system. The method may also include providing 706 a lower linkage member pivotally coupled at a first pivot point with the frame and pivotally coupled at a second pivot point with the rear suspension system, and where the lower linkage member includes a bottom bracket shell.

The method schematic diagram described above is generally set forth as a logical flow chart diagram. As such, the depicted order and labeled steps are indicative of representative examples. Other steps and methods may be conceived that are equivalent in function, logic, or effect to one or more steps, or portions thereof, of the methods illustrated in the schematic diagrams. Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown.

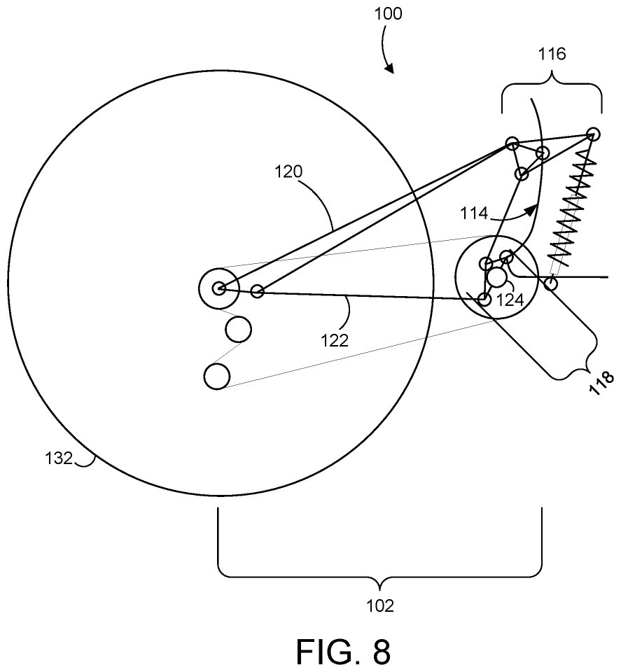

FIG. 8 is a side view diagram illustrating another example of a bicycle frame having a rear suspension system, in accordance with examples of the subject disclosure. FIG. 8 depicts a six-bar linkage suspension system with the bottom bracket shell 124 integrated into the lower linkage member 118. It is contemplated that the features of the present disclosure are useful in any configuration of a rear suspension system 102 that includes pivoting upper linkage members and lower linkage members, as opposed to mountain bike suspension systems that are known as single-pivot systems. In other words, although a 6-bar linkage system is depicted here, and other linkage systems are depicted in FIGS. 1-6, it is contemplated that a lower linkage member with an integrated bottom bracket shell is useful in other rear suspension systems that include an upper linkage member that pivotally couples a rear triangle with the bike frame.

The present disclosure may be embodied in other specific forms without departing from its spirit or essential characteristics. The described examples are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A bicycle comprising:
a frame having a head tube coupled to a top tube and a down tube;
a seat tube coupled to the top tube and the down tube;
an upper linkage member pivotally coupled at a first pivot point with the bicycle frame and pivotally coupled at a second pivot point with a rear suspension system; and
a lower linkage member pivotally coupled at a first pivot point with the bicycle frame and pivotally coupled at a second pivot point with the rear suspension system, and where the lower linkage member includes a bottom bracket shell.

2. The bicycle of claim 1, where the bottom bracket shell is integrally formed with the lower linkage member.

3. The bicycle of claim 1, where the lower linkage member comprises a third pivot point.

4. The bicycle of claim 3, further comprising a shock absorber coupled at a first end with a structural member of the bicycle frame and coupled at a second end with the third pivot point of the lower linkage member.

5. The bicycle of claim 1, where the upper linkage member comprises a third pivot point.

6. The bicycle of claim 5, further comprising a shock absorber coupled at a first end with a structural member of the bicycle frame and coupled at a second end with the third pivot point of the upper linkage member.

7. The bicycle of claim 1, where rear suspension system comprises a seatstay and a chainstay oriented to form, together with a structural member, a rear triangle.

8. The bicycle of claim 7, where the rear suspension system is configured to support a wheel and move the wheel, with respect to the bicycle frame, from an extended position to a compressed position.

9. The bicycle of claim 7, where the upper linkage member pivotally couples to an end of the seatstay.

10. The bicycle of claim 7, where the lower linkage member pivotally couples to an end of the chainstay.

11. The bicycle of claim 7, further comprising a rear braking system coupled to the seatstay.

12. The bicycle of claim 7, further comprising a rear braking system coupled to the chainstay.

13. A system comprising:
a bicycle frame comprising:
a head tube coupled to a top tube and a down tube;
a seat tube coupled to the top tube and the down tube;
a rear suspension system comprising:
an upper linkage member pivotally coupled at a first pivot point with the bicycle frame and pivotally coupled at a second pivot point with the rear suspension system; and
a lower linkage member pivotally coupled at a first pivot point with the bicycle frame and pivotally coupled at a second pivot point with the rear suspension system, and where the lower linkage member includes a bottom bracket shell; and
a shock absorber configured to bias the rear suspension system with respect to the bicycle frame.

14. The system of claim 13, where the bottom bracket shell is integrally formed with the lower linkage member.

15. The system of claim 13, where the lower linkage member comprises a third pivot point.

16. The system of claim 15, where the shock absorber is coupled at a first end with a structural member of the bicycle frame and coupled at a second end with the third pivot point of the lower linkage member.

17. The system of claim 13, where the upper linkage member comprises a third pivot point.

18. The system of claim 17, further comprising a shock absorber coupled at a first end with a structural member of the bicycle frame and coupled at a second end with the third pivot point of the upper linkage member.

19. The system of claim 13, where rear suspension system comprises a seatstay and a chainstay oriented to form, together with a structural member, a rear triangle.

20. A method of making a suspension system for supporting a frame of a vehicle on at least one wheel of the vehicle, the method comprising:
providing the frame of a vehicle having a head tube, a down tube, and a seat tube;
providing an upper linkage member pivotally coupled at a first pivot point with the frame and pivotally coupled at a second pivot point with a rear suspension system; and
providing a lower linkage member pivotally coupled at a first pivot point with the frame and pivotally coupled at a second pivot point with the rear suspension system, and where the lower linkage member includes a bottom bracket shell.
